(19) United States
(12) Patent Application Publication
(10) Pub. No.: US 2007/0012744 A1
(43) Pub. Date: Jan. 18, 2007

(54) Power actuated fastener system

(75) Inventor: Alfonso Losada, Bridgeport, CT (US)

Correspondence Address: JAMES R. CYPHER, 405 14TH STREET, SUITE 1607, OAKLAND, CA, 94612, US

(73) Assignee: Simpson Strong-Tie Company, Inc.

(21) Appl. No.: 11/527,257

(22) Filed: Sep. 25, 2006

Related U.S. Application Data
(62) Division of application No. 09/729,389, filed on Dec. 4, 2000, now Pat. No. 7,111,767.
Application No. 09/729,389 is a continuation-in-part of application No. 09/403,109, filed on Oct. 14, 1999, now Pat. No. 6,273,316.
(60) Provisional application No. 60/046,826, filed on Apr. 24, 1997.

(51) Int. Cl. B25C 3/00

(52) U.S. Cl. 227/107

(57) ABSTRACT

An automated power actuated gun having a fastener feeding track with guides for holding a fastener assembly having a plate and attached stud in a firing position. The power actuated gun is attached to the fastener feeding track so as to permit relative movement there between. A fastener loading control prevents movement of an adjacent fastener assembly held within the fastener feeding track from moving until the barrel of the power actuated gun is clear. The relative movement between the fastener feeding track and the power actuated gun is utilized to activate a control mechanism to perform various functions on the power actuated gun, such as to advance a charge or to push a trigger firing the power actuated gun. The functioning of the power actuated gun is automated, greatly increasing productivity of a worker and eliminating the need of the worker to tediously load by hand and fire individual fastener assemblies.

### RELATED APPLICATIONS

This application claims the benefit of United States Provisional Application No. 60/046,826 filed Apr. 24, 1997.

This application is a divisional application of U.S. patent application Ser. No.: 09/729,789, filed Dec. 4, 2000, which is a continuation in part of U.S. patent application Ser. No. 09/403,109, filed Oct. 14, 1999, now U.S. Pat. No. 6,273,316, which is the national stage of an International Application No. PCT/US98/08060 having an international filing date of Apr. 15, 1998. U.S. application Ser. No. 09/403,109, filed Oct. 14, 1999, also having been divided, resulting in U.S. application Ser. No. 09/875,488, filed Nov. 19, 2002, now U.S. Pat. No. 6,481,611.

### FIELD OF THE INVENTION

The present invention relates generally to power actuated fasteners used in construction, and particularly to an automated power actuated fastener tool with track feeding.

### BACKGROUND OF THE INVENTION

Power actuated guns are frequently used in construction. The power actuated guns are used to fasten building materials to a hard surface. Power actuated guns generally use a powder charge or a cartridge to drive a nail or a stud with great force into a hard surface, such as cement. Fasteners are often used that are comprised of a shaped plate with a nail or stud placed there through. Often, an angled plate having a hole therein is used so that a wire or other device can be fastened thereto. An example of a fastener which is used with a power actuated gun is disclosed in U.S. Pat. No. 4,736,923 entitled “Fastener Assembly” issuing to Losada on Apr. 12, 1988, which is herein incorporated by reference. Power actuated fastener guns have been used in combination with the fastener assemblies. The stud or nail of the fastener assembly is placed within the barrel of the power actuated gun and placed adjacent a hard surface. The power actuated gun is then fired driving the stud or nail into the hard surface. Often, the fasteners will be used in ceiling applications with the power actuated gun being placed on a pole, the fastener assembly being inserted within the bore of the power actuated gun and the whole device raised to the ceiling with the pole. When pressure is applied to the pole, the power actuated gun fires, driving the nail or stud into the hard surface. The power actuated gun is then lowered for insertion of another fastener assembly. Often, it is also necessary to cock the gun or to advance the powder charge to render the gun operable for another firing. While this operation is satisfactory for many applications, it also requires a great deal of time to manually load each fastener assembly prior to firing the power actuated gun. Therefore, there is a need to improve and make more productive the use of power actuated guns and fastener assemblies so as to increase their efficiency and make each worker more productive. Increases in productivity are essential in the construction field where ever escalating labor costs make it essential that each worker as productive as possible. Therefore, there is a continuing need to increase the productivity of each worker and to automate the construction process as much as possible. One system that has greatly advanced the power actuated gun art is disclosed in U.S. patent application Ser. No. 09/403,109 filed Oct. 14, 1999 and entitled “Fastener Feeding System For Power Actuated Gun” invented by Losada, which is herein incorporated by reference. While this device has dramatically improved the productivity of workers, there is a need for yet further improvement.

### SUMMARY OF THE INVENTION

In one embodiment of the present invention, a feeding system for use with a power actuated gun comprises a track to hold a plurality of fastener assemblies having guides for positioning a fastener assembly over a surface and to be received by the barrel of a power actuated gun. Once in position and held by the guides, the power actuated gun is moved relative to the feeding system, causing the guide to release the fastener assembly and the fastener assembly to be driven into a surface upon the firing of the power actuated gun.

In another embodiment of the present invention, a fastener loading control is used to prevent a fastener assembly adjacent the fastener assembly in position for firing from advancing prematurely.

In another embodiment of the present invention, the relative movement between the power actuated gun and an attachment is used to control various operations of the power actuated gun. In one embodiment, the relative movement is used to advance the charge on a strip, making the power actuated gun ready for another firing. In another embodiment, the relative movement is used to activate a trigger so as to fire the power actuated gun when the fastener assembly is in position.

In another embodiment, a stop is used to prevent the power actuated gun from firing when a fastener is not in position.

Accordingly, it is an object of the present invention to make laborers or workers more productive and thereby reduce construction costs.

It is another object of the present invention to provide a power actuated fastening system that has a smooth operation and is easy to use.

It is a further object of the present invention to use the relative movement between a power actuated gun and an attachment to automate various functions.

It is a further object of the present invention to provide a power actuated fastener system that is safe to use.

It is an advantage of the present invention that it saves time.

It is a further advantage of the present invention that the relative movement between the power actuated gun and an attachment is used to automate many different functions.

It is another advantage of the present invention that the power actuated gun cannot be fired unless a fastener assembly is in the proper firing position.

It is a feature of the present invention that a track holds a plurality of fastener assemblies.

It is a further feature of the present invention that a fastener loading control prevents the advancement of a fastener assembly within the track until the adjacent fastener assembly is cleared.

It is another feature of the present invention that a rod and spring provides relative movement between the power actuated gun and an attachment.

It is yet another feature of the present invention that a stop is used to prevent the firing of the power actuated gun without a fastener assembly being in the proper firing position.

These and other objects, advantages, and features will become readily apparent in view of the following more detailed description.

### BRIEF DESCRIPTION OF THE DRAWINGS

FIG. 1 is a perspective view of an embodiment of the present invention.

FIG. 2 is a side elevational view of an embodiment of the present invention.

FIG. 3A is a partial cross section of an embodiment of a fastener loading control in a first position.

FIG. 3B is a partial cross section of an embodiment of a fastener loading control in a second position.

FIG. 3C is a plan view of an embodiment of the present invention.

FIG. 4A is a partial cross section of another embodiment of a fastener loading control.

FIG. 4B is a partial perspective view of the fastener loading control embodiment illustrated in FIG. 4A.

FIG. 5A is a partial cross section of another embodiment of a fastener loading control.

FIG. 5B is a partial perspective view of the fastener loading control embodiment illustrated in FIG. 5A.

FIG. 6A is a perspective view of a portion of another embodiment of the present invention.

FIG. 6B is a cross section taken along line 6B-6B in FIG. 6A.

FIG. 7A is a partial cross section of another embodiment of the present invention illustrating the operation of a firing safety device in a first position.

FIG. 7B is a cross section of a portion of an embodiment of the present invention illustrating the firing safety device illustrated in FIG. 7A in a second position.

FIG. 8 is a partial elevational view of an embodiment of the present invention illustrating a charge advancing control mechanism.

FIG. 9 is a side elevational view of a portion of the present invention illustrating the charge advancing control /mechanism illustrated in FIG. 8.

FIG. 10A schematically illustrates an embodiment of the present invention and the charge advancing control mechanism in a first position. FIG. 10B schematically illustrates the operation of the embodiment of the present invention and the charge advancing control mechanism in a second position.

FIG. 10C schematically illustrates the operation of the embodiment of the present invention and the charge advancing control mechanism in a third position.

FIG. 11A more clearly illustrates the operation of the charge advancing control mechanism in another first position.

FIG. 11B more clearly illustrates the operation of the charge advancing control mechanism in another second position.

FIG. 11C more clearly illustrates the operation of the charge advancing control mechanism in another third position.

FIG. 11D more clearly illustrates the operation of the charge advancing control mechanism in another fourth position.

FIG. 12A schematically illustrates the operation of a trigger control mechanism in a first non-firing position.

FIG. 12B schematically illustrates the operation of the trigger control mechanism in a second firing position.

FIG. 13 schematically illustrates an embodiment of the present invention having a curved fastener feeding track.

FIG. 14 schematically illustrates in an exploded view another means for moving the gun relative to an attachment or track.

### DETAILED DESCRIPTION OF THE PREFERRED EMBODIMENTS

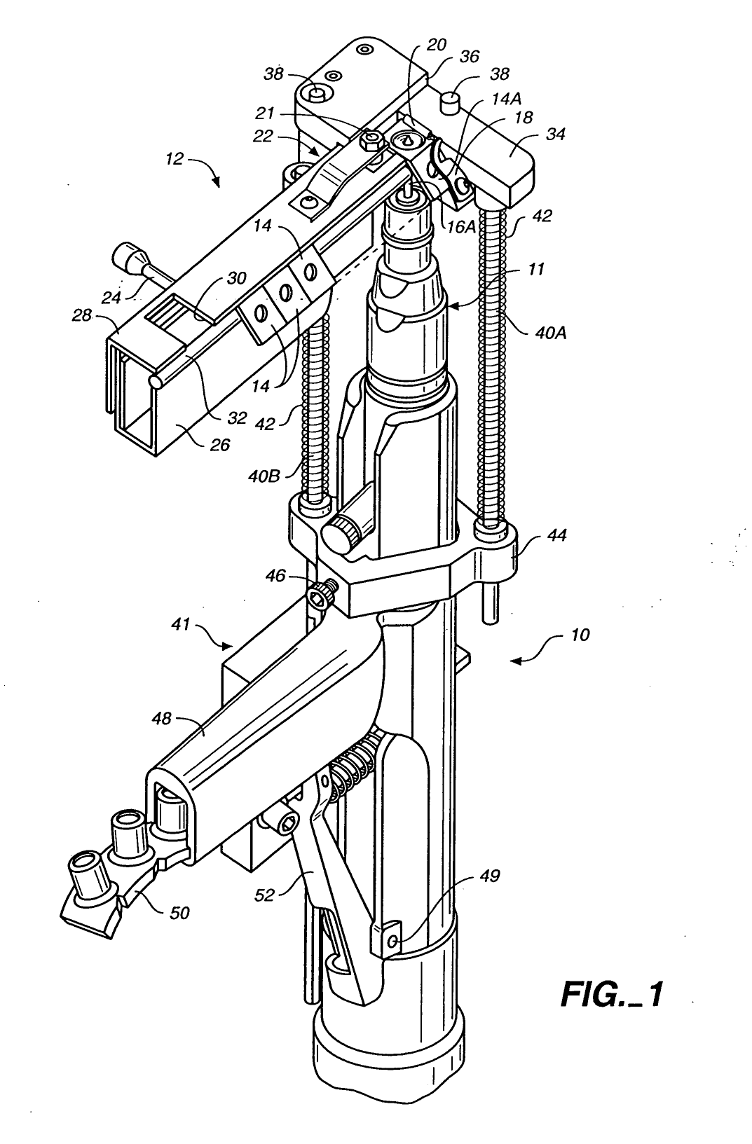

FIG. 1 illustrates an embodiment of the present invention. A power actuated gun or tool 10 is illustrated. The power actuated gun 10 may be based on any commercially available power actuated gun. Generally, there are several different types of operation of power actuated guns. For example, some power actuated guns may have to be cocked, some may fire when pressure is applied to the rear of the gun, some may require the pulling of a trigger to fire the gun, and some may require the charge to be manually advanced. The present invention may be adapted to any of a variety of these commercially available power actuated guns. Additionally, many power actuated guns may be modified in accordance with the teachings of the present invention in order to improve the power actuated gun. A fastener feeding track 12 is attached to the body of the power actuated gun 10 so as to be positioned over a barrel 11. The fastener feeding track 12 contains a plurality of fastener assemblies comprising a fastener plate 14 with a nail or a stud 16A frictionally fastened to the fastener plate 14 though an aperture formed therein. A fastener assembly placed within a channel in the fastener feeding track 12 is advanced forward into a position over the barrel 11. A rear guide 18 is made of a spring metal that holds a portion of a positioned fastener plate 14A. A side guard 20 also made from spring steel contacts a side of the positioned fastener plate 14A, holding it into position over barrel 11. Guides 18 and 20 only illustrate one means for holding the fastener assembly in position. A fastener loading control 22 is positioned adjacent the fastener assembly plate 14A in position over the barrel 11 and is used to control the loading of the next adjacent fastener assembly plate 14 into position once the gun 10 is fired. The fastener assembly loading control 22 prevents an adjacent fastener assembly plate 14 from prematurely advancing into position before the barrel 11 of the power actuated gun is in position to receive another fastener assembly. Lever 24 having a coiled spring attached, not shown, biases the plurality of fastener assembly plates 14 down the track 12, forcing the fastener assemblies into position sequentially over the barrel 11. The track 12 comprises a channel piece 26 with an angled piece 28. An opening 30 is formed within the angled piece 28. A radius slide 32 is attached to the channel piece 26 and aids in the sliding of the plates 14 along the track 12. A support plate 34 has a spacer plate 36 attached thereto. Formed on the spacer plate 36 and the support plate 34 are feet 38. Contact 21, forming a part of the fastener loading control 22, may also act as a support or foot so as to provide three points of contact when the track 12 is placed adjacent a surface. A short rod 40A has a spring 42 surrounding it. Short rod 40A is slidably held within a collar 44. Short rod 40A has an end fixed to the support plate 34. A long rod 40B is attached to another portion of the track 12 and similarly has a spring 42. One end of the long rod 40B is slidably attached to collar 44. The distal end of the long rod 40B is attached to a control mechanism 41. The positioning of the track 12 and the tension within the spring 42 may be adjusted by axially sliding collar 44 on the body of the power actuated gun 10. The position of the collar 44 may be locked into place by set screw 46. A fixed handle 48 contains therein a charge strip 50. Charge strip 50 contains a plurality of powder charges that are used to drive the fastener assembly. A charge advance lever 52 is pivoted by pivot 49 and is used to advance the charge strip 50. From FIG. 1, the general operation of this embodiment of the present invention should be appreciated. A plurality of fastener assemblies, including plate 14, are inserted through opening 30 and slid down the channel piece 26 while lever 24 is drawn rearward or away from the barrel 11 of the power actuated gun 10. After a plurality of fastener assemblies have been inserted through opening 30 and slid down the track 12, lever 24 may be released causing an end plate, not illustrated, to contact the last fastener assembly, forcing it against adjacent fastener assemblies until a fastener assembly is placed in a firing position adjacent the support plate 34. The guides 18 and 20 retain the fastener assembly in the firing position. After placing the track 12 adjacent a surface through which the fastener assembly is to be driven, the power actuated gun is forced upward or towards the track 12 so as to cause the stud 16A to enter the barrel 11. The plate 14A, it is pushed through the guides 18 and 20 so as to cause the fastener assembly to be securely forced against the surface into which it is to be driven. The application, in this particular power actuated gun, of additional force causes the gun to automatically fire. Upon release of pressure from the rear of the power actuated gun 10, the springs 42 cause the barrel 11 to move away from the track assembly 12. However, the fastener loading control 22 prevents a fastener assembly from advancing within the channel piece 26 until after the barrel 11 is withdrawn a sufficient distance and the contact 21 and feet 38 are removed a predetermined distance from the surface. The control mechanism 41 then causes the lever 52 to be depressed, advancing the charge strip 50. The gun is now ready for another firing with another fastener assembly secured positioned in a firing position.

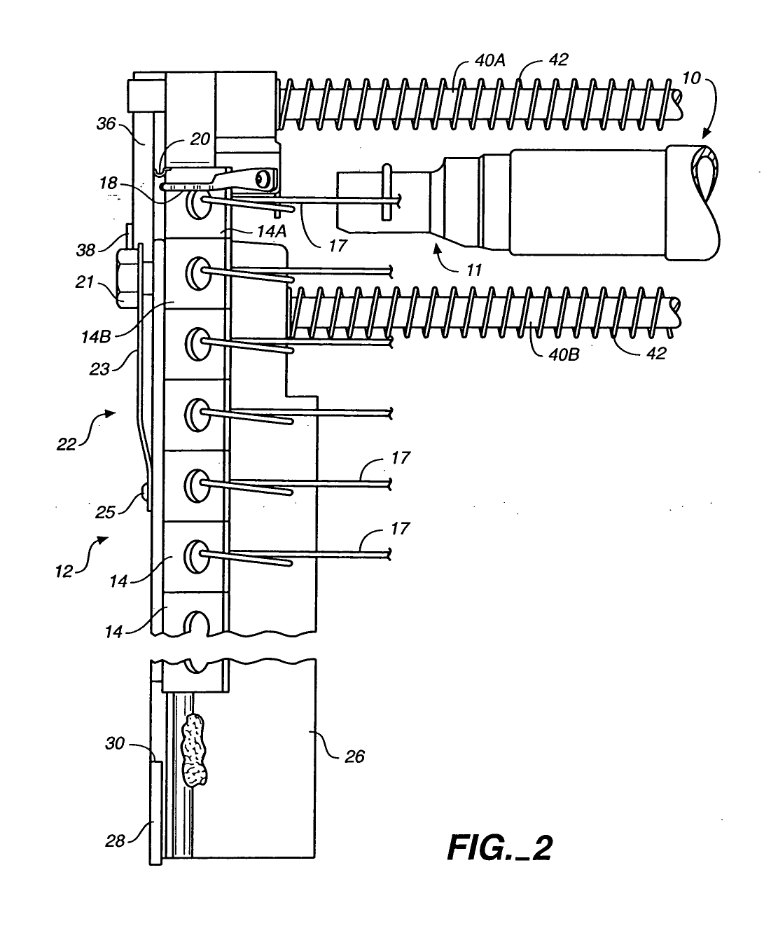

FIG. 2 more clearly illustrates the track 12 and the fastener loading control 22. The plurality of fastener assemblies have a plurality of shaped plates 14 that abut one another. Additionally, wires 17 are shown attached to plates 14. A particularly prevalent application of power actuated guns is to hang wire assemblies from ceilings, such that objects may be attached to the wires 17 and suspended or supported, for example a suspended ceiling. Guides 18 and 20 hold plate 14A of the fastener assembly into position over barrel 11. Plate 14B of adjacent fastener assembly is held in position by fastener loading control 22. The fastener loading control 22 comprises a contact 21 which is positioned adjacent a surface, forcing it toward the angled plate 28 and fastener plate 14B. Spring 23 normally biases the contact 21 away from the top surface of the angled plate 28. A screw 25 holds one end of the spring 23 onto a surface of the angled plate 28 while the distal end of the spring 23 has contact 21 attached thereto. Accordingly, the adjacent fastener assembly having plate 14B is prevented from advancing until spring 23 biases contact 21 upward to release the plate 14B. This assures that the plate 14B is not advanced until after the barrel 11 is retracted or biased away from the channel 26 by springs 42. Only after barrel 11 is sufficiently clear is the plate 14B released to advance into a firing position.

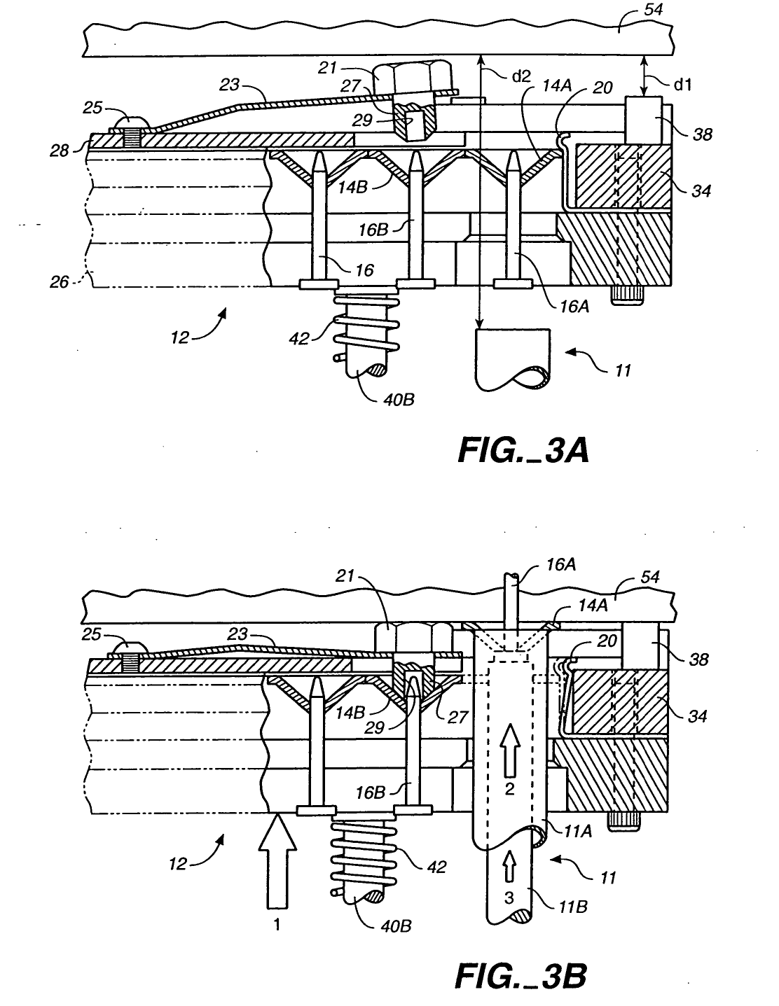

FIGS. 3A and 3B more clearly illustrate the operation of the fastener loading control 22. As the track 12 is placed adjacent a hard surface 54 and the distance d, between the foot 38 and the hard surface 54 is reduced, the contact 21 also contacts the hard surface 54 causing extension 27 downward towards stud 16B. As the extension 27 moves downward, the point of stud 16B enters space 29 within the extension 27. Accordingly, when distance d₁ between the surface 54 and the foot 38 is reduced and the foot 38 contacts the surface 54, the distance d₂ between barrel 11 and the surface 54 is then reduced and the barrel 11 advances. Accordingly, as is illustrated in FIG. 3B, as the track 12 moves in the direction of arrow 1 and the foot 38 contacts the surface 54, the outer barrel 11A contacts plate 14A, stripping the plate 14A from the guide 20. The extension 27 engulfs the point of shaft 16B, securely holding t adjacent plate 14B in position. After the fastener assembly and plate 14A are firmly against surface 54, the inner plunger 11B is forced downward in the direction of arrow 3 by an explosive charge so as to drive the stud 16A within the hard surface 54. After firing, the inner plunger 11B and the outer barrel 11A are withdrawn away from the surface 54. Once the barrel 11 is withdrawn a sufficient distance and the power actuated gun is continued to be withdrawn from the surface 54 such that a gap forms between the surface 54 and foot 38, the contact 21 will then be biased upward or away by spring 23, causing release of the adjacent stud 16B. Once the stud 16B is released, the adjacent fastening assembly and the plate 14B is advanced to the firing position over barrel 11.

FIG. 3C is a plan view illustrating the surface of the track 12 and the holding of plate 14A. Plate 14A of the fastener assembly can clearly be seen in a position held by guides 18 and 20 and an adjacent fastener assembly having plate 14B. The fastener loading control 22 can also more clearly be seen. Each plate 14 advances the adjacent plate 14 down the track 12 as respective fastener assemblies are driven into a surface with the power actuated gun.

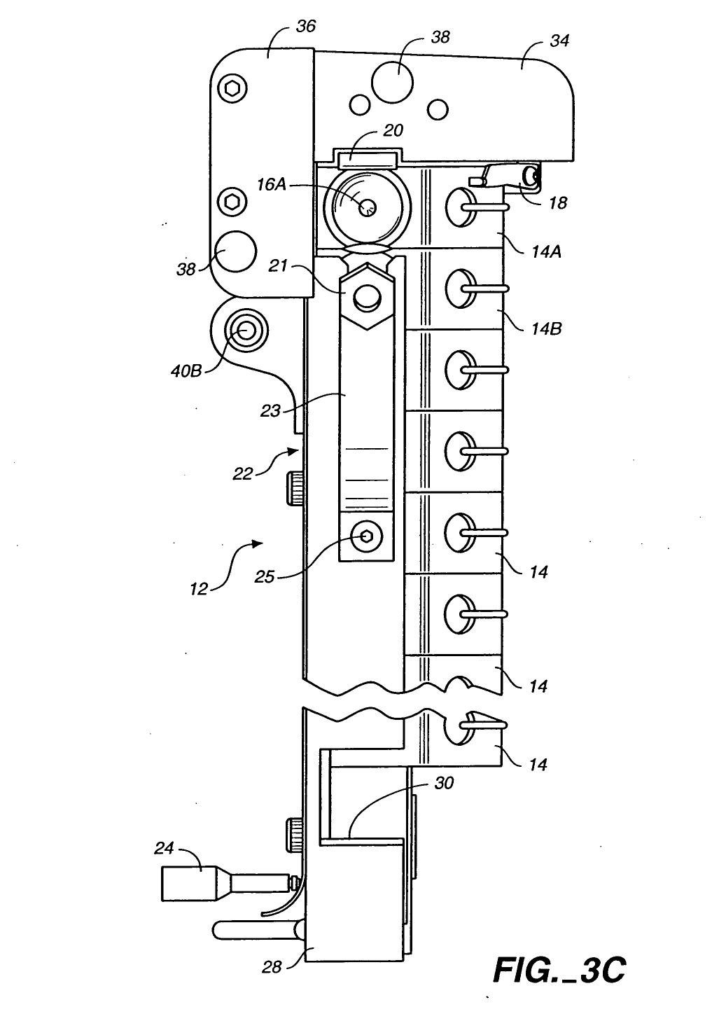

FIGS. 4A and B illustrate another embodiment of a fastener loading control. In this embodiment, when a surface 54 contacts contact 121 forcing an extension 127 downward, the extension 127 is forced between plate 14A and adjacent plate 14B. Accordingly, plate 14B is prevented from moving toward the firing position until after the biasing force in spring 123 forces the contact 121 away from the fastener assemblies as the track is removed from the surface 54.

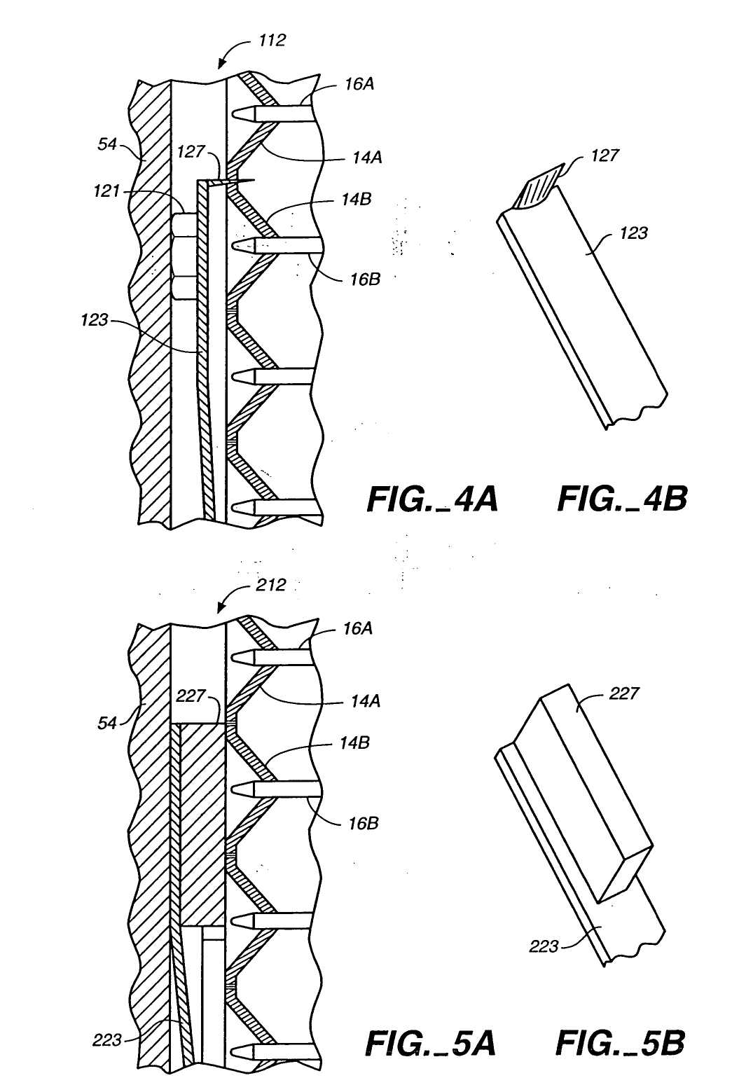

FIGS. 5A and B illustrate another embodiment of a fastener loading control. In this embodiment, surface 54 forces a block extension 227 adjacent portions of plate 14B as track 212 is placed in position adjacent surface 54. Friction then retains the plate 14B in position, preventing it from advancing forward as the fastener assembly and plate 14A are driven into surface 54. Upon removal of the track 212 from the surface 54, the biasing force in spring 223 forces the block extension 227 away from the track 212 and thereby releases the fastener assembly having plate 14B. The plate 14B is then free to advance into the firing position. Clearly, other equivalent fastener loading control devices are possible. For example, each fastener plate may have hole therein through which an extension can be inserted preventing unintentional movement of the fastener plate.

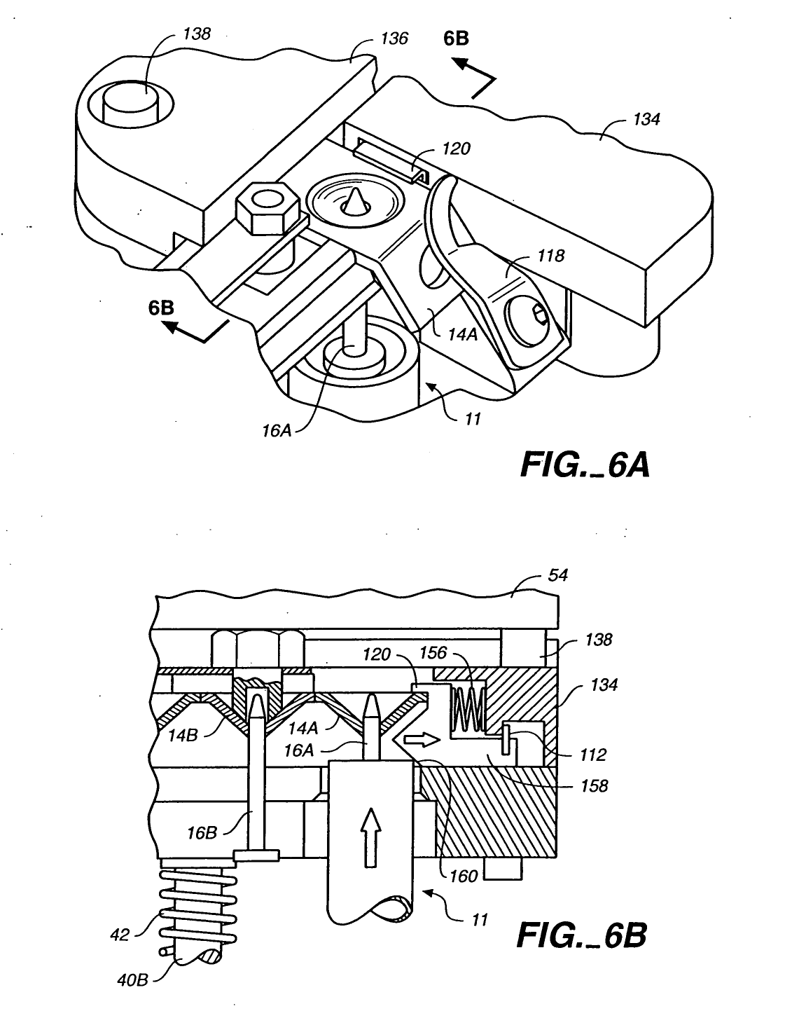

FIGS. 6A and B illustrate another guiding mechanism used in holding plate 14A of a fastener assembly in a firing position over barrel 11. In this embodiment, a support plate 134 houses a cam driven side guide 120. Support plate 134 is attached to a spacer plate 136, which has a foot 138 thereon. A rear guide 118 holds the angled portion of plate 14A. FIG. 6B is a partial cross section taken along line 6B-6B in FIG. 6A. FIG. 6B more clearly illustrates the operation of the cam driven side guide 120. A spring 156 forces a guide slide 158 towards plate 14A. Stop 162 prevents the guide slide 158 from being forced out of the support plate 134. Accordingly, when plate 14A is in a firing position, it is retained between the guide 120 and an adjacent plate 14B. As the barrel 11 is moved adjacent the plate 14A in the direction of the arrow on barrel 11, nail or stud 16A enters the barrel 11 and a corner of barrel 11 contacts cam surface 160 on the guide slide 158. The guide slide 158 is forced in the direction of the arrow on the guide slide 158 against the bias force of spring 156. The guide 120 is then caused to release the plate 14A while the stud 16A is securely retained within the barrel 11. The plate 14A of the fastener assembly is then free to be moved against the surface 54 and driven therein.

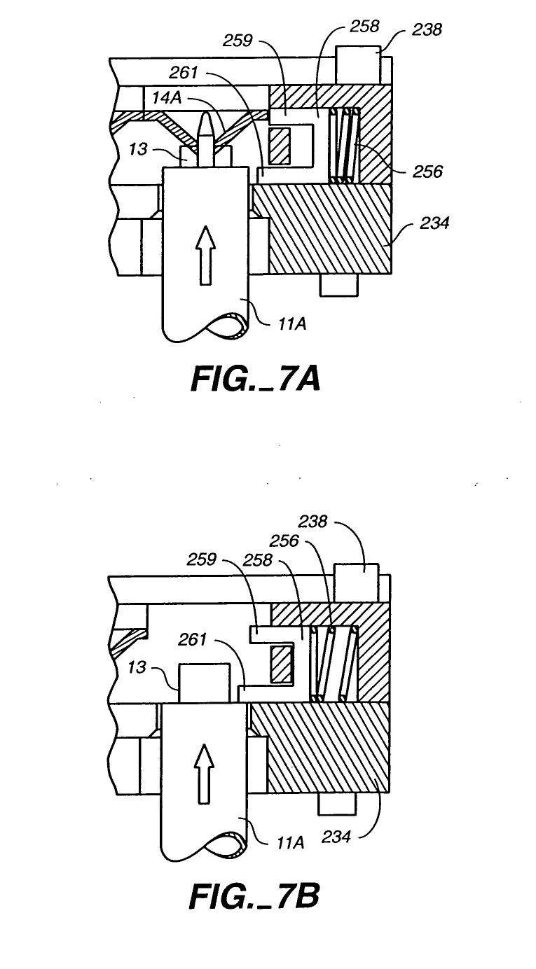

FIGS. 7A and B illustrate a safety stop designed to prevent the power actuated gun from firing should a fastener assembly not be placed in a firing position. Many power actuated guns have a safety feature such that if a portion of the barrel, for example an inner portion 13, does not contact a sufficiently hard surface, a safety mechanism within the power actuated gun will cause the gun not to fire. Generally, this prevents the gun from firing unless the barrel is placed against a solid surface. However, in most applications, the barrel can be placed against a solid surface without a fastener assembly placed therein and the power actuated gun will still be able to fire. This may result in a dangerous firing of the gun, damage to the plunger of the gun, and at the least a waste of a charge. The embodiment illustrated in FIGS. 7A and B provide a safety feature associated with a track so as to prevent the firing of a power actuated gun should a fastener assembly not be in a firing position. In FIG. 7A, a track is illustrated with a foot 238 placed adjacent a hard surface, not illustrated, and the outer barrel 11A being advanced with an inner safety barrel 13 forced against the plate 14A. The outer barrel 11A is allowed to continue to advance, placing sufficient force on the inner safety barrel 13A to cause the power actuated gun to fire. The fastener plate 14A pushes a detection leg 259 of a stop slide 258 compressing spring 256. The stop leg 261 is therefore clear of the outer barrel 11A. FIG. 7B illustrates operation of the safety feature when a fastener assembly is not positioned in the firing position. When a fastener assembly is not positioned in the firing position, the absence of a plate 14A, illustrated in FIG. 7A, causes the detection leg 259 to move forward or towards the barrel 11A due to the bias of spring 256. The stop leg 261 therefore is moved into position so as to strike the outer barrel 11A as it is advanced in the direction of the barrel on 11A. The stop leg 261 prevents any further advancement of the outer barrel 11A. Accordingly, the inner safety barrel 13 does not contact a hard surface preventing the power actuated gun from firing. Therefore, should the fastener assembly supply run out of the track or should a fastener assembly not be in a firing position for any reason, the safety device illustrated in FIGS. 7A and B will prevent the power actuated gun from firing. Other equivalent safety devices may be used to prevent the unintentional firing of the power actuated gun. For example a stop may be place at other locations. Additionally, it should be appreciated that the present invention is inherently safer than prior individually hand loaded power actuated guns. By providing automated feeding the risk of injury to an operator during loading of the barrel directly is substantially reduced or eliminated. Should the power actuated gun misfire during loading, serious injury could result.

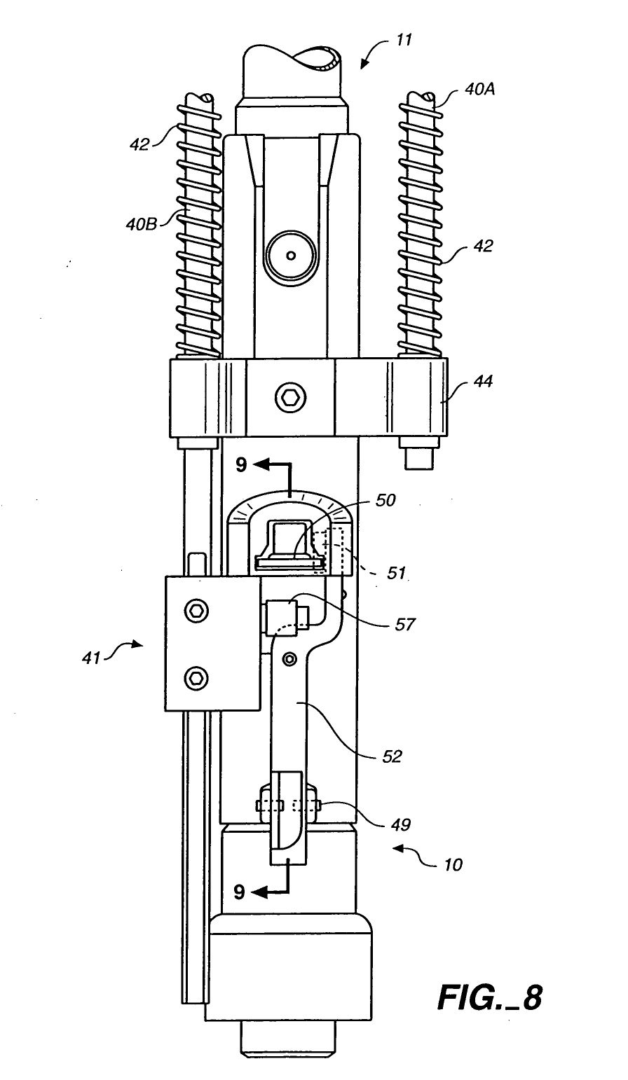

FIGS. 8 through 11 illustrate the operation of a control mechanism 41 that takes advantage of the relative movement between a track 12 and the power actuated gun 10. Sliding rods 40A and 40B and springs 42 permit relative movement between an attachment to the power actuated gun 10 and the power actuated gun 10. Long rod 40B may be attached to a control mechanism 41. Generally, the control mechanism 41 may be used to operate any feature of a power actuated gun. However, in this embodiment, the control mechanism 41 operates a charge advancing lever 52 used to advance a charge strip 50. The charge advancing lever 52 has a tab 51 thereon which contacts the charge strip 50. The lever 52 is pivoted at one end by pivot 49. A cam 57 forms a part of the control mechanism 41 and activates or depresses lever 52.

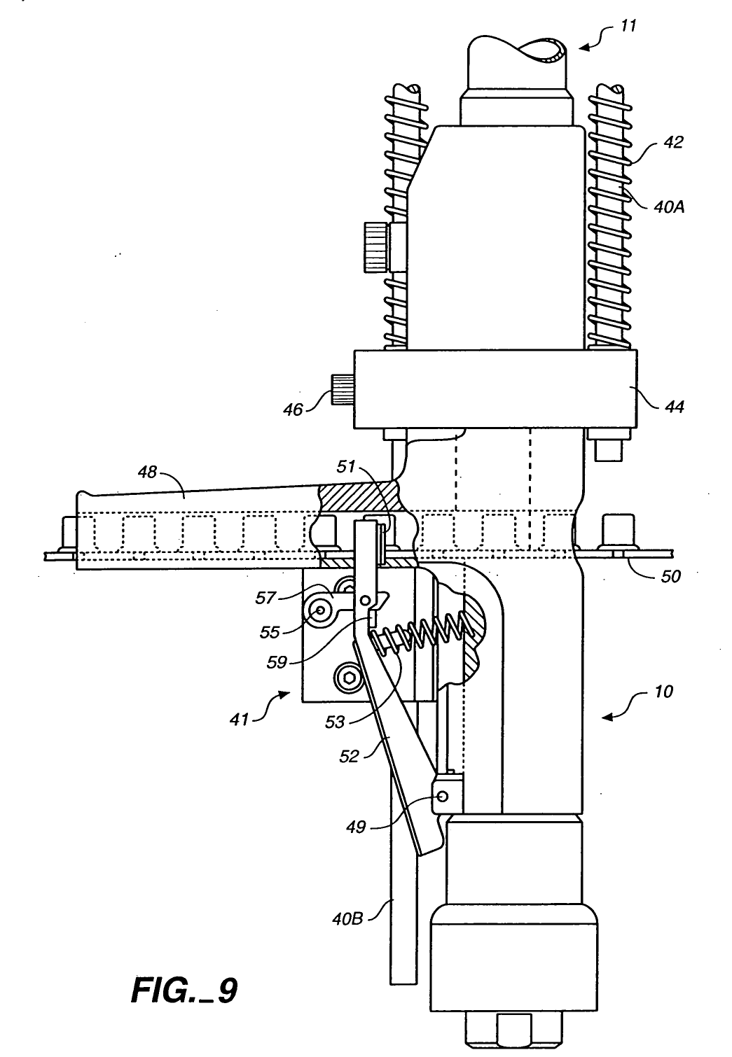

FIG. 9 is a partial cross section taken along line 9-9 in FIG. 8. FIG. 9 more clearly illustrates the operation of the control mechanism 41. A spring 53 is attached to charge advance lever 52, biasing the charge advance lever 52 away from the body of the power actuated gun 10. The cam 57 fits in an opening within a fork of the lever 52. A stop 59 prevents the cam 57 from pivoting on pivot 55.

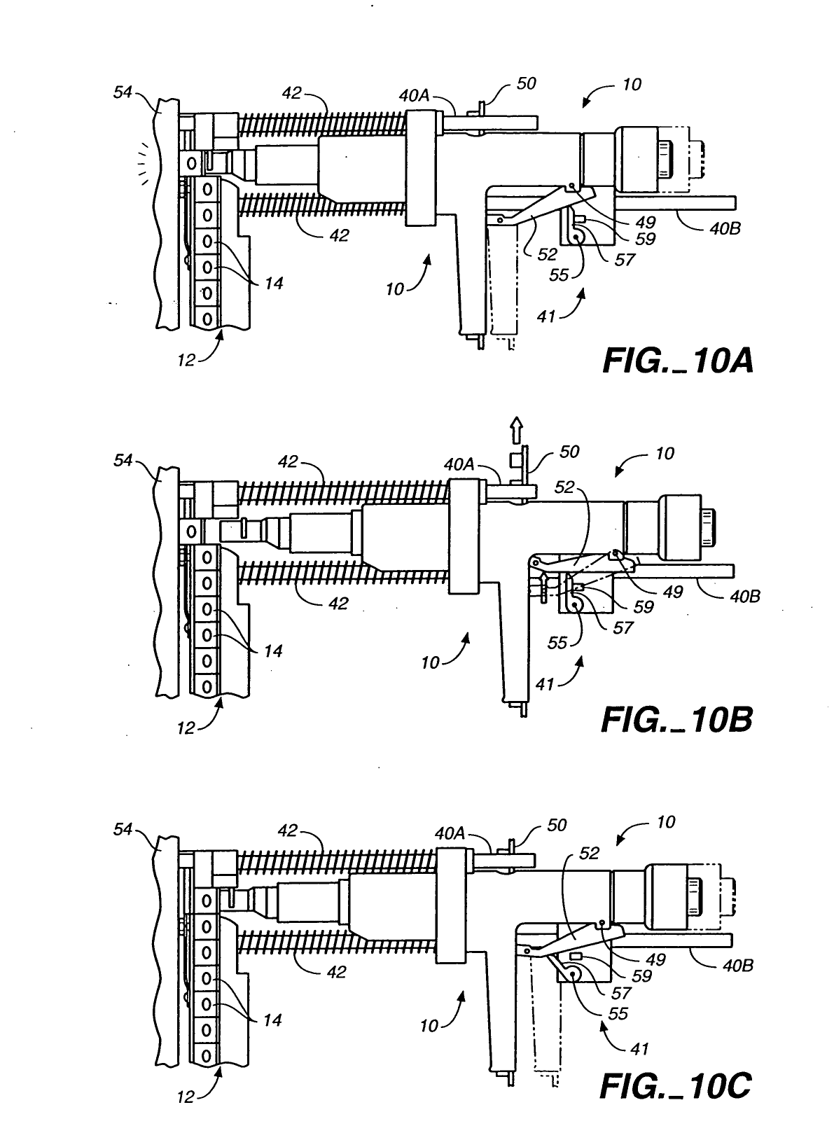

FIGS. 10A-C schematically illustrate the general operation of the control mechanism 41 and its use advancing a charge strip 50 readying the power actuated gun 10 for a subsequent firing. In FIG. 10A, the power actuated gun 10 is moved forward, causing a fastener assembly in the firing position to be forced against the surface 54. Springs 42 are compressed and the power actuated gun may be fired. This embodiment of the power actuated gun 10 is fired when continuous pressure is applied to the rear of the power actuated gun 10 and the barrel of the power actuated gun 10 is adjacent a hard surface. This embodiment of the power actuated gun 10 is often used on the end of a pole when applying fastener assemblies to a ceiling. However, this embodiment of the power actuated gun requires the charge strip 50 to be advanced to provide sequential firing of the power actuated gun 10. The control mechanism 41 uses the relative motion between the power actuated gun 10 and a track 12 to automate the advancing of the charge strip 50. This makes it unnecessary to bring the power actuated gun 10 down from the end of a pole when the power actuated gun 10 is used in applying multiple fastener assemblies to a ceiling. FIG. 10B illustrates the operation of the control mechanism 41 after a fastener assembly is driven into surface 54. The springs 42 providing a relative movement between the power actuated gun 10 and a track 12. The bias of the springs 42 move the power actuated gun 10 and handle 52 away from the track 12. The cam 57 is forced upward by the stop 59, resulting in the handle 52 being compressed against the body of the power actuated gun 10 as illustrated in the direction of the arrow adjacent the lever 52. The charge strip 50 is thereby advanced as illustrated by the arrow adjacent strip 50. FIG. 10C illustrates operation of the control mechanism 41 when a new fastener assembly is placed in a firing position and the power actuated gun 10 is moved closer to the track 12 compressing springs 42. As the power actuated gun 10 and the attached lever 52 are moved closer to the track 12, the cam 57 is caused to pivot counterclockwise on pivot 55 away from stop 59. The cam 57 slides along the surface of lever 52. Accordingly, lever 52 is not compressed towards the body of the power actuated gun 10. Therefore, the charge strip 50 is not advanced while the barrel of the power actuated gun 10 pushes another fastener assembly away from the track and against the surface 54.

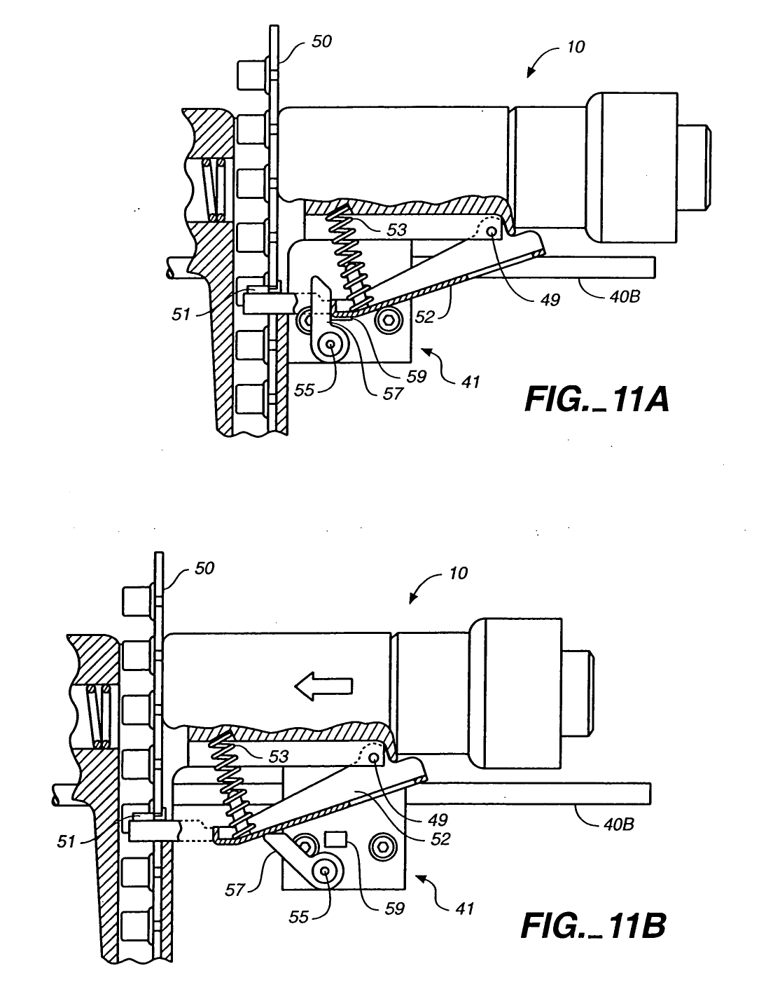

FIGS. 11A-D more clearly illustrate the operation of the control mechanism 41. FIG. 11A illustrates the control mechanism 41 in a resting position. The cam 57 extends through an opening in the lever 52. Advancing tab 51 is in position adjacent the charge strip 50. Spring 53 biases the lever 52 away from the body of the power actuated gun 10. FIG. 11B illustrates the operation of the control mechanism 41 as the power actuated gun 10 is moved to the left or in the direction of the arrow on the body of the power actuated gun 10. As the handle 52 is moved with the power actuated gun 10 in the direction of the arrow on the body of power actuated gun 10, the control mechanism 41 attached to the long rod 40B remains stationary. As a result of the contact between the lever 52 and the cam 57,. the cam 57 is pivoted counterclockwise on pivot 55 away from stop 59. FIG. 11C illustrates the full advancement of the power actuated gun 10 and the attached lever 52 with the cam 57 having sufficient clearance with the angled lever 52 so as not to depress the lever 52 or compress spring 53. During the movement illustrated by FIGS. 11A-C, the lever 52 has not moved resulting in no advancement of the charge strip 50. FIG. 11D illustrates operation of the control mechanism 41 as the power actuated gun 10 is moved in the direction of the arrow illustrated on the body of the power actuated gun 10. As the attached lever 52 is moved in the direction of the arrow on the body of the power actuated gun 10, cam 57 is forced clockwise against stop 59. This causes the lever 52 to pivot toward the body of the power actuated gun 10 and compressing spring 53. The advancing tab 51 is caused to move with the lever 52 resulting in the charge strip 50 to advance in the direction of the arrow adjacent charge strip 50. Accordingly, in this embodiment of the present invention, the relative motion between an attachment to a power actuated gun, for example a track, and the power actuated gun, results in the ability to control or activate different features on the power actuated gun. Other equivalent features of the power actuated gun may be controlled with the motion created by the power actuated gun.

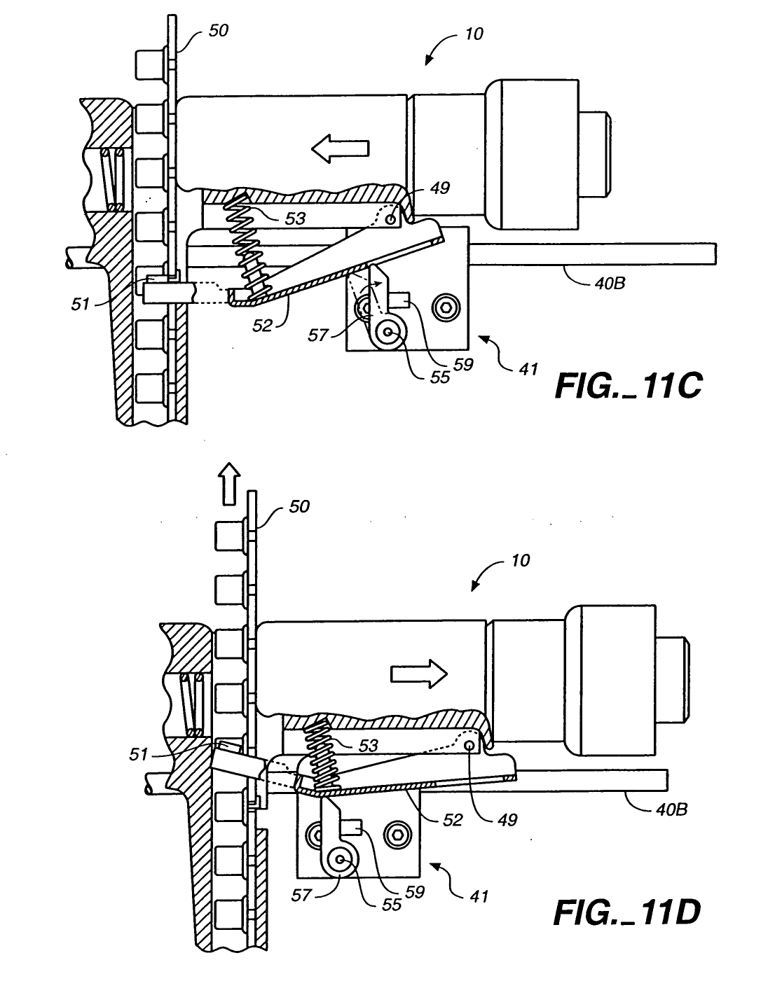

FIGS. 12A-B illustrate another type of control mechanism that may be utilized as a result of the relative movement between a track and a power actuated gun. In some power actuated guns, an external trigger must be activated before the gun will fire. In power actuated gun applications utilizing a pole to elevate the power actuated gun to a ceiling, a wire is sometimes used connected to a trigger to fire the gun from a ground location. However, this is often inconvenient and requires the operator to pull a wire mechanism to fire the gun. The embodiment illustrated in FIGS. 12A-B provides a trigger control mechanism that automates the firing of a power actuated gun 310. The power actuated gun 310 has a trigger 364 which must be activated or depressed in order to fire. This embodiment of the power actuated gun 310 may also have a charge advance mechanism 341, similar to that previously illustrated in greater detail. A control rod 368 is attached to a track 312 containing a plurality of fastener assemblies having plates 14. A plunger or activator 370 is attached to the trigger control rod 368. The plunger or activator 370 may be spring loaded to the trigger control rod 368. However, the spring must be sufficiently strong or provide a force greater than that necessary to activate the trigger 364. This assures that any slight variances in distance or travel will not result in a gap between the plunger or activator 370 and the trigger 364, resulting in the power actuated gun 310 not to fire. FIG. 12A illustrates the position of the power actuated gun 310 prior to advancing the power actuated gun 310 towards the track 312 and against the surface 54. FIG. 12B illustrates the positioning of the power actuated gun 310 moved upward adjacent the surface 54 so as to compress springs 342. Accordingly, a fastener assembly is stripped from the track 312 and caused to abut surface 54. The trigger is then activated by the plunger 370 causing the power actuated gun 310 to fire. Accordingly, the embodiment illustrated in FIGS. 12A-B can fully automate the firing of a power actuated gun 310 of the type having a trigger 364. Therefore, in combination with the track 312 and control mechanisms 341 and 366, the power actuated gun 310 may be repeatedly fired without having to lower and adjust or feed the power actuated gun 10. Therefore, when the power actuated gun 310 is placed on a pole and used in a ceiling application, the power actuated gun 310 does not have to be lowered for insertion of a new fastener assembly, advancement of the charge, and a separate lever or cable pulled once in position to fire. The present invention therefore greatly facilitates the rapid firing of multiple rounds or charges to very rapidly sequentially drive fastener assemblies.

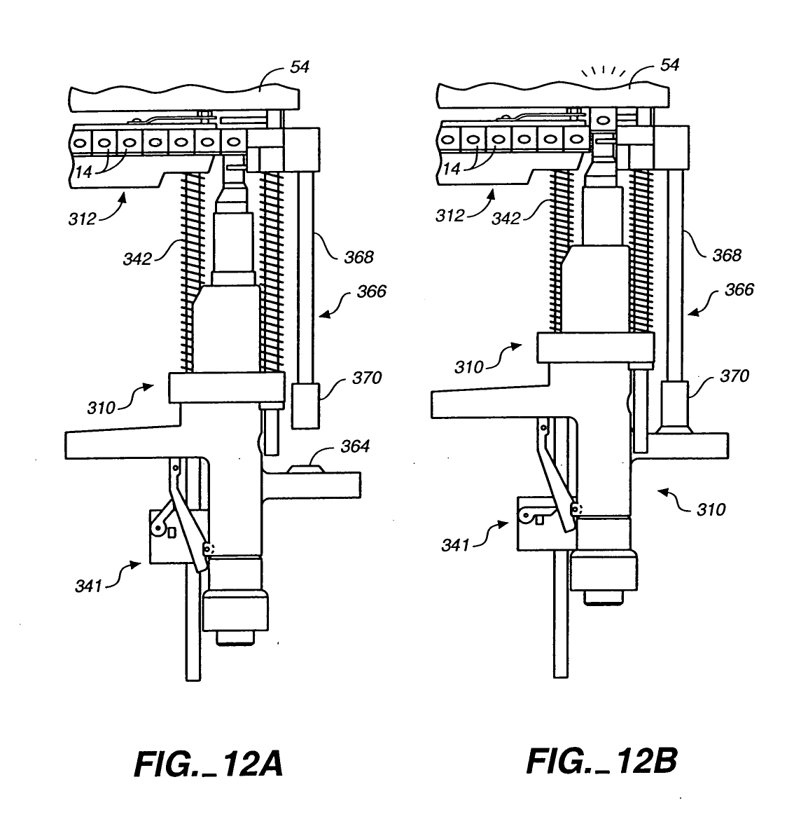

FIG. 13 illustrates another embodiment of a power actuated gun 410 having a control mechanism 441 and a curved track 412. The curved track 412 operates substantially similarly to the previously described linear tracks in holding plates 14 of a fastener assembly. However, the curved track 412 makes the power actuated gun 410 more compact and permitting the invention to fit in tighter places than if the track was not curved.

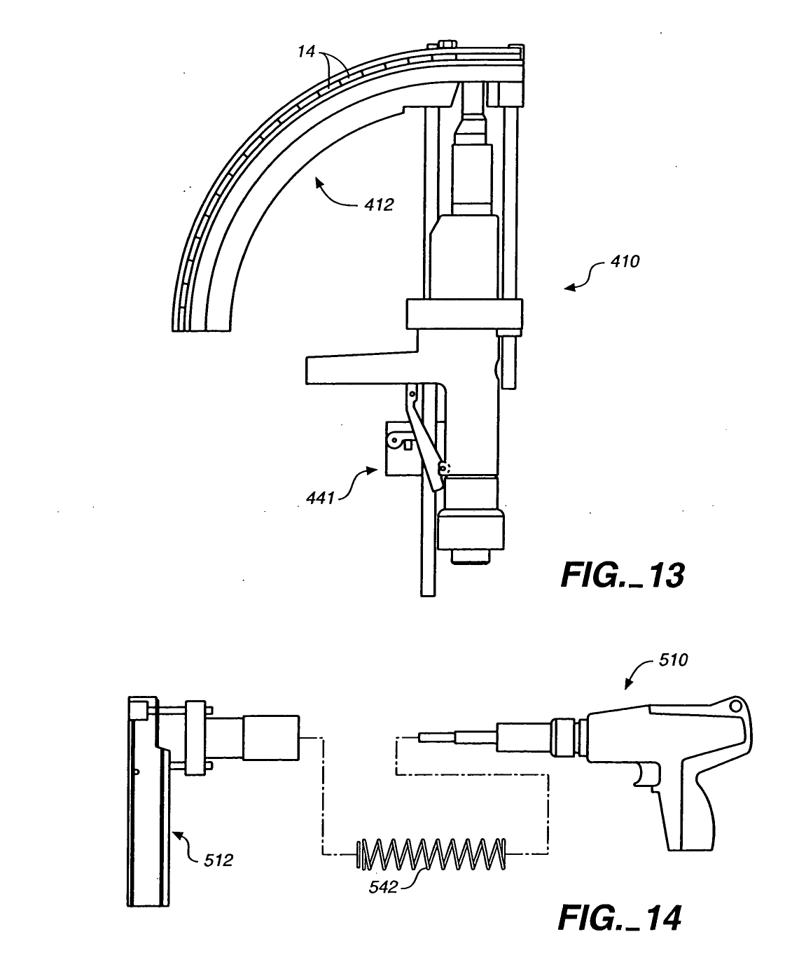

FIG. 14 illustrates another embodiment of a power actuated gun 510 showing a different means for moving a track 512 relative to the power actuated gun 510. A single concentric spring 542 may be placed over the barrel of the power actuated gun 510 and within a single cylinder attached to a track 512.

Accordingly, it should be appreciated that the present invention may encompass a variety of different embodiments, only several of which have been illustrated in detail. It will be clear that the principles of the present invention can be applied to many different structures without departing from the spirit and scope of the invention. The present invention provides the automation of a power actuated gun that saves considerable time. Fastener assemblies can rapidly be positioned and driven with the worker or operator taking virtually no time between firing to reload a fastener assembly or advance the charge.

1. A fastener feeding track for use with a power actuated gun comprising:
a track having a channel adapted to contain a plurality of fastener assemblies comprising a fastener plate and an attached stud, said track adapted to attach to the power actuated gun;
a plurality of guides formed at one end of the channel, said plurality of guides holding the fastener plate in a firing position over a barrel of the power actuated gun; and
a spring biasing said track away from the power actuated gun so at to permit one of the plurality of fastener assemblies to be positioned over the barrel of the power actuated gun,
whereby the power actuated gun may be moved relative to said track to remove the one of the fastener assemblies from said track and drive the stud into a surface upon firing of the power actuated gun.

2. A fastener feeding track as in claim 1 further comprising:
a loading control attached to said track.

3. A fastener feeding track as in claim 1 wherein said loading control comprises:
a spring attached at one end to said track;
a contact attached to the other end of said spring;
an extension attached to said contact, said extension positioned to contact a fastener assembly,
whereby movement of the fastener assembly is prevented until released by said extension.

4. A fastener feeding track as in claim 1 further comprising:
a control mechanism attached said track, said control mechanism controlling an operation of the power actuated gun.

5. A fastener feeding track as in claim 4 wherein:
said control mechanism comprises a charge advancing mechanism.

6. A fastener feeding track as in claim 4 wherein said charge advancing mechanism comprises:
a stop fixed relative to said track;
a pivoting cam fixed relative to said stop and a charge advancing lever of a power actuated gun,
whereby when the power actuated gun is moved in a direction towards said track the pivoting cam pivots away from said stop, and when the power actuated gun is moved in a direction away from said track the pivoting cam is caused to contact said stop and depresses the charge advancing lever.

7. A fastener feeding track as in claim 4 wherein:
said control mechanism comprises a trigger pushing mechanism.

8. A fastener feeding track as in claim 1 further comprising:
means for preventing firing of the power actuated gun if a fastener assembly is not in the firing position.

9. A fastener feeding track as in claim 1 wherein:
said plurality of guides contact the fastener plate on at least two adjacent sides of said fastener plate.

10. A fastener feeding track for use with a power actuated gun comprising:
means for advancing in a sequential arrangement a plurality of fastener assemblies, each of the plurality of fastener assemblies comprising a fastener plate and an inserted stud;
means for positioning and holding one of the plurality of fastener assemblies over a barrel of the power actuated gun;
means for moving the power actuated gun towards said means for positioning and holding, whereby the one of the plurality of fastener assemblies is forced form said means for positioning and holding and attached to a surface; and
means, attached to said means for advancing, for preventing another one of the plurality of fastener assemblies from advancing before the barrel of the power actuated gun is clear of the another one of the plurality of fastener assemblies,
whereby the plurality of fastener assemblies may be fastened to a surface sequentially without having to reload the fastener feeding track with fastener assemblies.

11. A fastener feeding track as in claim 10 further comprising:
means, coupled to said track, for preventing the power actuated gun from firing if one of the plurality of fastener assemblies is not in a firing position.

12. A fastener feeding track as in claim 10 further comprising:
means, coupled to said track, for controlling an operation of the power actuated gun.

13. A fastener feeding track as in claim 10 wherein:
said means for positioning and holding comprises a plurality of guide means of spring material.

14. A fastener feeding track as in claim 10 wherein:
said means for moving comprises a plurality of rods and springs.

15. A power actuated gun system for use in attaching a fastener assembly having a plate and a stud to a surface comprising:
a power actuated gun having a barrel adapted to receive the stud;
a first rod, one end of said first rod attached to said power actuated gun;
a second rod, one end of said second rod attached to said power actuated gun;
a plate attached to the other end of said first rod and the other end of said second rod;
a first spring placed over said first rod biasing said plate away from the barrel of said power actuated gun;
a second spring placed over said second rod biasing said plate away from the barrel of said power actuated gun;
a channel adapted to receive a fastener assembly attached to said plate;
an angled plate attached to said channel having an opening at on end adapted receive a fastener assembly;
a side guide attached to said plate;
a rear guide attached to said plate, said side and rear guides position to hold a first plate of a first fastener assembly in a firing position over the barrel of the power actuated gun;
a spring attached to said angle plate;
a contact attached to said spring; and
an extension attached to said contact, said extension positioned over a second fastener assembly adjacent the first fastener assembly in the firing position, whereby when said angled plate is positioned adjacent the surface the extension is caused to hold the second fastener assembly in position.

16. A power actuated gun system as in claim 15 further comprising:
means for preventing the firing of said power actuated gun if a fastener assembly is not in position over the barrel of said power actuated gun.

17. A power actuated gun system as in claim 15 further comprising:
means for controlling a mechanism on said power actuated gun.

18. A power actuated gun system used in attaching a fastener assembly having a plate and an attached stud to a surface comprising:
a power actuated gun having a barrel adapted to receive the stud;
a track adapted to receive a plurality of fastener assemblies attached to said power actuated gun;
a fastener loading control attached to said track;
a plurality of guides associated with said track so as to position a fastener assembly over the barrel of said power actuated gun; and
means for preventing the firing of said power actuated gun if a fastener assembly is not in position over the barrel of said power actuated gun,
whereby a potentially dangerous firing of said power actuated gun is prevented.

19. A power actuated gun system comprising:
a power actuated gun;
an attachment attached to said power actuated gun;
means, attached to said power actuated gun and said attachment, for proving relative movement between said power actuated gun and said attachment; and
means, coupled to said attachment, for controlling a mechanism on said power actuated gun,
whereby relative movement between said power actuated gun and said attachment is used to control a mechanism on said power actuated gun.

20. A power actuated gun system as in claim 19 wherein:
said means for providing relative movement comprises a plurality of rods and springs.

21. A power actuated system as in claim 19 wherein:
the mechanism comprises a charge advance lever.

22. A power actuated gun system as in claim 19 wherein:
the mechanism comprises a trigger

23. A method of attaching a fastener assembly to a surface comprising the steps of:
placing a plurality of fastener assemblies in a track;
attaching the track to a power actuated gun having a barrel;
positioning a first fastener assembly of the plurality of fastener assemblies over the barrel of the power actuated gun;
moving the barrel of the power actuated gun towards the first fastener assembly positioned over the barrel of the power actuated gun;
contacting the first fastener assembly with the barrel of the power actuated gun;
firing the power actuated gun;
moving the barrel of the power actuated gun away from the first fastener assembly; and
preventing a second fastener assembly of the plurality of fastener assemblies adjacent the first fastener assemblies positioned over the barrel from moving until the barrel is clear of the second fastener assembly,
whereby the plurality of fastener assemblies may be attached to a surface without reloading the track.

24. A power actuated gun system comprising:
a power actuated gun having a barrel;
a fastener feeding track attached to said power actuated gun;
means, attached to said fastener feeding track, for holding a first fastener assembly in a firing position over the barrel; and
a fastener loading control attached to said fastener feeding track, said fastener loading control capable of moving into position upon contact with a substrate selectively preventing movement of a second fastener assembly adjacent the first fastener assembly in the firing position over the barrel, whereby when the barrel is clear of the adjacent second fastener assembly said fastener loading control permits movement of the second fastener assembly.

25. A power actuated gun system as in claim 24 wherein:
the first and second fastener assemblies each comprise a stud frictionally held within a fastener plate.
